(19) United States
(12) Patent Application Publication
(10) Pub. No.: US 2009/0145684 A1
(43) Pub. Date: Jun. 11, 2009

(54) Safety apparatus for rear steerable vehicle wheels

(75) Inventor: Kenneth A. Sherwin, West Lafayette, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 12/001,170

(22) Filed: Dec. 10, 2007

(51) Int. Cl. B62D 5/04; G06F 19/00

(52) U.S. Cl. 180/410; 701/43

(57) ABSTRACT

A steering apparatus (10) turns steerable wheels (14, 16) of a vehicle (12) having first (14) and second (16) sets of steerable wheels. The steering apparatus (10) includes first and second steering assemblies and a braking mechanism (200). The first steering assembly is actuatable to effect turning of the first set (14) of steerable wheels. The second steering assembly is actuatable to effect turning of the second set (16) of steerable wheels. The braking mechanism (200) locks the second set of steerable wheels (16) in position in response to a failure of the second steering assembly.

### TECHNICAL FIELD

The present invention relates to a vehicle steering apparatus. More particularly, the present invention relates to a safety apparatus for rear steerable vehicle wheels.

### BACKGROUND OF THE INVENTION

Vehicle steering systems for turning more than one set of steerable vehicle wheels are known. Typically, such a steering system is adapted to turn a front set and a rear set of vehicle wheels in response to rotation of a vehicle hand steering wheel.

Such a steering system may include a selector switch for selecting the type of steering to be provided by the steering system. For example, the switch may include a first position that prevents turning of the rear set of steerable wheels and a second position that permits turning of the rear set of steerable wheels. When the switch is positioned in the second position, i.e., permitting the turning of the rear set of steerable wheels, rotation of the vehicle steering wheel results in the turning of the front set of steerable wheels and, rotation of the handwheel beyond a predetermined angular position results in rotation of both the front set and the rear set of steerable wheels.

### SUMMARY OF THE INVENTION

The present invention relates to a steering apparatus for turning steerable wheels of a vehicle having first and second sets of steerable wheels. The steering apparatus includes first and second steering assemblies and a braking mechanism. The first steering assemblies is actuatable to effect turning of the first set of steerable wheels. The second steering assemblies is actuatable to effect turning of the second set of steerable wheels. The braking mechanism locks the second set of steerable wheels in position in response to failure of the second steering assembly.

In another aspect of the present invention a steering apparatus is responsive to rotation of a steering wheel for turning steerable wheels of a vehicle having first and second sets of steerable wheels. The steering apparatus includes a first steering assembly, a second steering assembly, a sensor, and a braking mechanism. The first steering assembly is actuatable to effect turning of the first set of steerable wheels. The first steering assembly is actuated in response to rotation of the steering wheel. The second steering assembly is actuatable to effect turning of the second set of steerable wheels. The second steering mechanism is actuated in response to rotation of the steering wheel. The sensor senses a steering position of the first set of steerable wheels and provides a steering signal indicative of the sensed steering position. The braking mechanism locks the second set of steerable wheels in position in response to a failure of the second steering assembly.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic block diagram illustrating a steering apparatus constructed in accordance with the present invention;

FIG. 2 illustrates an example integral steering gear, in partial section, of the type that may be used with a steering apparatus in accordance with the present invention;

FIG. 3 is a view taken along line 3-3 in FIG. 2;

FIG. 4 is a view taken along line 4-4 in FIG. 2;

FIG. 5 is a flow diagram illustrating an example control process that may be performed by a controller of the steering apparatus of FIG. 1; and

FIG. 6 is an example friction brake that may be used with the steering apparatus of FIG. 1.

### DETAILED DESCRIPTION OF AN EXAMPLE OF THE INVENTION

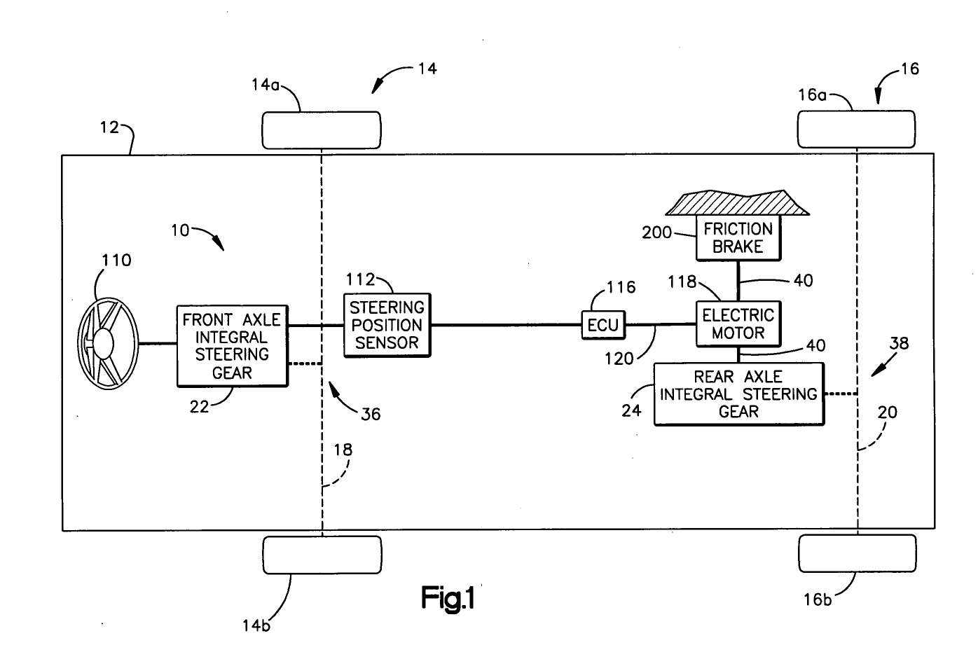

FIG. 1 is a schematic block diagram illustrating an example steering apparatus 10 constructed in accordance with the present invention. The steering apparatus 10 is mounted to a vehicle 12 having a front set 14 of steerable wheels and a rear set 16 of steerable wheels. The front set 14 of steerable wheels includes wheels 14a and 14b and the rear set 16 of steerable wheels includes wheels 16a and 16b. Wheels 14a and 14b are mounted on opposite ends of a front axle 18 in a manner such that operation of front steering linkage 36 results in turning of wheels 14a and 14b. Likewise, wheels 16a and 16b are mounted on opposite ends of a rear axle 20 in a manner such that operation of rear steering linkage 38 results in turning of wheels 16a and 16b.

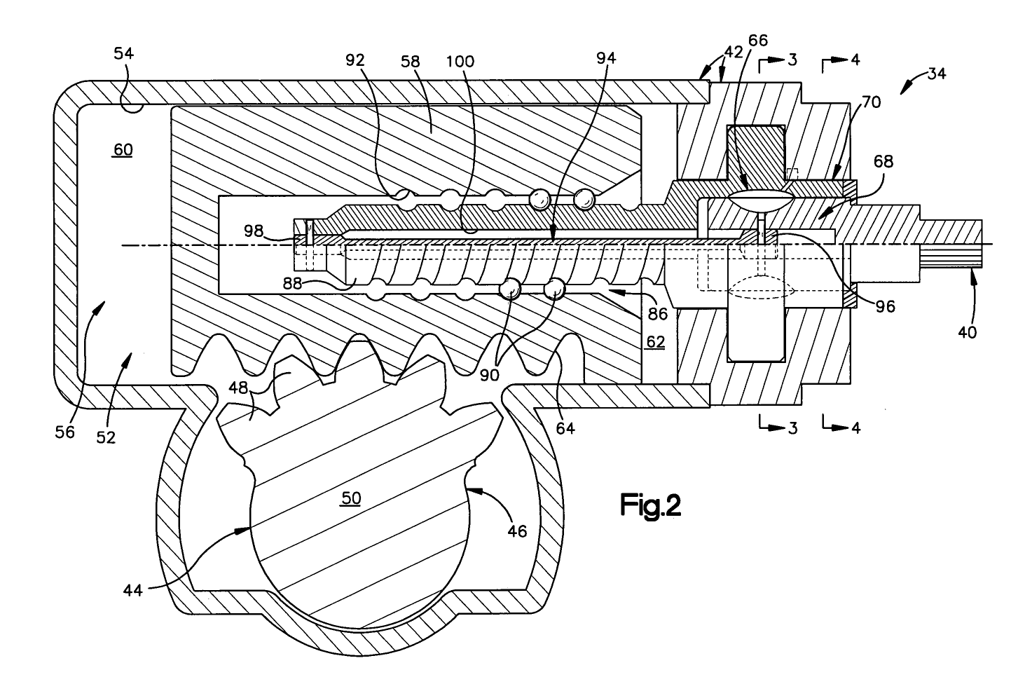

The steering apparatus 10 includes a front steering mechanism 22, such as a front steering gear, and a rear steering mechanism 24, such as a rear steering gear. The front steering gear 22 and the rear steering gear 24 may be integral steering gears. An exemplary integral steering gear 34 that may be used for the front steering gear 22 and the rear steering gear 24 is illustrated in FIG. 2.

The integral steering gear 34 of FIG. 2 includes a housing 42 and a drive mechanism 44. The drive mechanism 44 is moved in response to rotation of an input shaft 40 of the integral steering gear 34. The drive mechanism 44 includes a sector gear 46 having a plurality of teeth 48. The sector gear 46 is fixed on an output shaft 50 that extends outwardly through an opening in the housing 42 of the integral steering gear 34. The output shaft 50 is typically connected to a pitman arm (not shown) that is, in turn, connected to the steering linkage associated with the integral steering gear 34. The steering linkage, shown schematically at 36 (FIG. 1), associated with the front steering gear 22 includes the front axle 18 and the steering linkage, shown schematically at 38, associated with the rear steering gear 24 includes the rear axle 20. Thus, as the sector gear 46 rotates, the output shaft 50 is rotated to operate the associated steering linkage 36 or 38. As a result, the associated steering linkage 36 or 38 is operated and the steerable wheels 14a and 14b or 16a and 16b associated with the axle 18 or 20 are turned. The steering linkages 36 and 38 may be operated by linearly moving the axles 18 and 20.

The integral steering gear 34 further includes a hydraulic motor 52 for moving the drive mechanism 44. The hydraulic motor 52 is located within the housing 42 of the integral steering gear 34. The housing 42 of the integral steering gear 34 has an inner cylindrical surface 54 defining a chamber 56. A piston 58 is located within the chamber 56 and divides the chamber 56 into opposite chamber portions 60 and 62. One chamber portion 60 is located on a first side of the piston 58 and the other chamber portion 62 is located on a second side of the piston 58. The piston 58 creates a seal between the respective chamber portions 60 and 62 and is capable of axial movement within the chamber 56.

A series of rack teeth 64 is formed on the periphery of the piston 58. The rack teeth 64 act as an output for the hydraulic motor 52 and mesh with the teeth 48 formed on the sector gear 46 of the drive mechanism 44. When the piston 58 moves axially, the rack teeth 64 of the piston 58 interact with the teeth 48 of the sector gear 46 to rotate the sector gear 46.

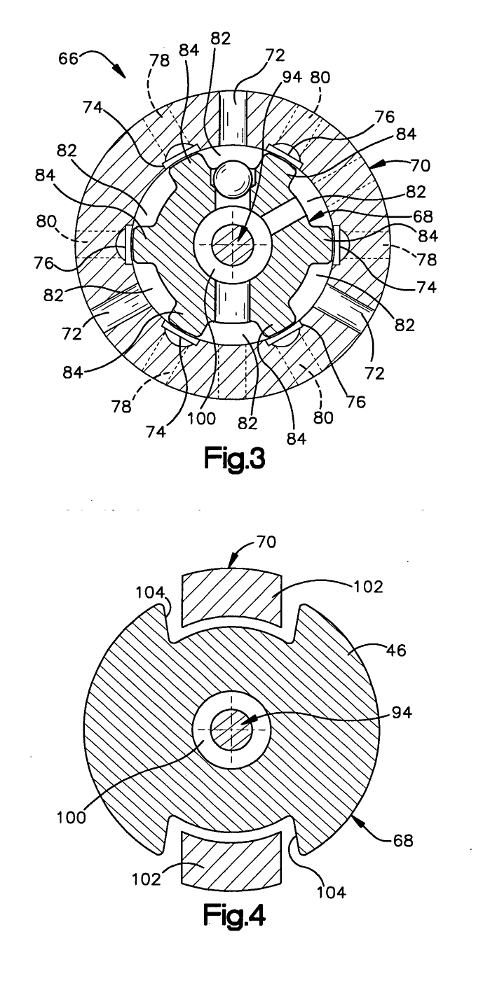

A pump (not shown) supplies hydraulic fluid from a reservoir (not shown) to the hydraulic motor 52. Typically, the engine (not shown) of the vehicle drives the pump. However, the pump could be driven otherwise, such as by a dedicated electric motor. The pump forces hydraulic fluid into an inlet (not shown) of the housing 42. The inlet directs the flow of the fluid to a directional control valve 66, shown in detail in FIG. 3.

The directional control valve 66 directs the fluid to an appropriate chamber portion 60 or 62 of the hydraulic motor 52. The flow of hydraulic fluid toward one of the chamber portions 60 or 62 increases the pressure within that respective chamber portion 60 or 62. When the pressure of one chamber portion 60 or 62 increases relative to the pressure of the other chamber portion 60 or 62, the piston 58 moves axially until the pressure within the chamber portions 60 and 62 again equalizes. As the piston 58 moves axially, the volume of one chamber portion, e.g., chamber portion 60, increases and the volume of the other chamber portion, e.g., chamber portion 62, decreases. The decreasing chamber portion is vented to allow a portion of the fluid contained in the decreasing chamber portion to escape. The escaping fluid exits the housing 42 via a return (not shown) and is directed into the reservoir.

An exemplary directional control valve 66 is shown in FIG. 3. The directional control valve 66 contains a valve core part 68 and a valve sleeve part 70. A portion of the valve core part 68 is contained within and is rotatable relative to the valve sleeve part 70.

The valve sleeve part 70 includes three radially directed passages 72 that extend from an outer circumference of the valve sleeve part 70 to an inner circumference of the valve sleeve part. Each of these radial passages 72 is supplied with hydraulic fluid that enters the housing 42 through the inlet. Two axially extending grooves 74 and 76 are associated with each radial passage 72. The axially extending grooves 74 and 76 are located on the inner circumference of the valve sleeve part 70. As shown in FIG. 3, one groove 76 is located clockwise from each radial passage 72 and one groove 74 is located counter-clockwise from each radial passage 72. The grooves 74 and 76 are equidistant from the respective radial passages 72. Each groove 74 leads to a passage 78 extending radially outward through the valve sleeve part 70. Each groove 76 leads to a passage 80 extending radially outward through the valve sleeve part 70. Each groove 74 and 76 and associated passage 78 and 80 is associated with a particular chamber portion 60 and 62 of the hydraulic motor 52. For example, with reference to FIG. 3, each groove 76 and associated passage 80 located immediately clockwise of a radial passage 72 will supply hydraulic fluid to the chamber portion 62; whereas, each groove 74 and associated passage 78 located immediately counter-clockwise from a radial passage 72 will supply hydraulic fluid to the chamber portion 60.

Six grooves 82 are located around the outer circumference of the valve core part 68. The valve core part 68 also includes six protrusions 84 or lands. A protrusion 84 separates adjacent grooves 82 on the outer circumference of the valve core part 68. Side walls of the protrusion 84 form side walls of the grooves 82.

When the valve core part 68 is located relative to the valve sleeve part 70 such that each protrusion 84 of the valve core part 68 is centered relative to a respective groove 74 or 76 of the valve sleeve part 70, the directional control valve 66 is in a neutral position. FIG. 3 illustrates the directional control valve 66 in the neutral position. In the neutral position, the pressure within each chamber portion 60 and 62 of the hydraulic motor 52 is the same so that the piston 58 is stationary. When the valve core part 68 is rotated relative to the valve sleeve part 70, access to one of the two associated grooves 74 or 76 of the valve sleeve part 70 is restricted by a protrusion 84 of the valve core part 68, while access to the other of the two associated grooves 74 or 76 is increased. This allows a greater amount of the hydraulic fluid to flow toward the open groove 74 or 76, resulting in an increase in pressure of the respective chamber portion 60 or 62 associated with that groove 74 or 76. As a result of the increased pressure within the respective chamber portion 60 or 62, the piston 58 of the hydraulic motor 52 is moved.

As an example, assuming that the valve core part 68 is rotated clockwise as viewed in FIG. 3, the groove 74 of the valve sleeve part 70 located on the counter-clockwise side of the radial passage 72 becomes blocked and the groove 76 located on the clockwise side of the radial passage 72 becomes open. Thus, a greater amount of the hydraulic fluid is directed toward the open groove 76. Pressure in the chamber portion 62 of the hydraulic motor 52 associated with the open groove 76 is increased relative to the pressure in chamber portion 60. As a result, the piston 58 is moved in an axial direction, leftward in FIG. 2, and rotates the sector gear 46, causing the steerable wheels of the vehicle to be turned in the appropriate direction.

The piston 58 of the hydraulic motor 52 contains a bore 86 (FIG. 2) that is open toward the directional control valve 66. The valve sleeve part 70 and a follow-up member 88 form an integral one-piece unit that is supported for rotation relative to the piston 58 by a plurality of balls 90. The outer periphery of the follow-up member 88 is threaded. The plurality of balls 90 interconnects the threaded outer periphery of the follow-up member 88 with an internal thread 92 formed in the bore 86 of the piston 58. As a result of the interconnecting plurality of balls 90, axial movement of the piston 58 causes the follow-up member 88 and the valve sleeve part 70 to rotate. The rotation of the follow-up member 88 and the valve sleeve part 70 returns the directional control valve 66 to the neutral position.

The valve core part 68 of the directional control valve 66 is fixedly connected to the input shaft 40 (FIG. 2). A first end 96 of a torsion bar 94 is fixed relative to the input shaft 40 and the valve core part 68. A second end 98 of the torsion bar 94 is fixed relative to the valve sleeve part 70 and the follow-up member 88. At least a portion of the torsion bar 94 extends through an axially extending bore 100 in the valve core part 68, as shown in FIGS. 2-4.

When the resistance to turning of the steerable wheels of the vehicle is below a predetermined level, rotation of the input shaft 40 of the integral steering gear 34 is transferred through the torsion bar 94 and causes rotation of the follow-up member 88. As a result, the directional control valve 66 remains in the neutral position. Rotation of the follow-up member 88 causes movement of the piston 58 and results in turning of the steerable wheels.

When resistance to turning the steerable wheels of the vehicle is at or above the predetermined level, rotation of the follow-up member 88 is resisted. As a result, rotation of the input shaft 40 of the integral steering gear 34 rotates the first end 96 of the torsion bar 94 relative to the second end 98 of the torsion bar. The rotation of the first end 96 of the torsion bar 94 relative to the second end 98 of the torsion bar twists the torsion bar 94 and causes the valve core part 68 to rotate relative to the valve sleeve part 70.

As discussed above, when the valve core part 68 rotates relative to the valve sleeve part 70, hydraulic fluid is directed toward one of the chamber portions 60 and 62. As a result, the piston 58 moves within the chamber 56. Movement of the piston 58 results in turning of the steerable wheels of the vehicle, as well as, rotation of the follow-up member 88. As discussed above, rotation of the follow-up member 88 rotates the valve sleeve part 70 until the directional control valve 66 is again in the neutral position. When the directional control valve 66 is in the neutral position, the twisting of the torsion bar 94 is removed and the first end 96 of the torsion bar 94 is no longer rotated relative to the second end 98 of the torsion bar.

As shown in FIG. 4, the valve sleeve part 70 also includes first and second lugs 102 that are disposed in diametrically opposed cut-outs 104 in the valve core part 68. Upon rotation of the valve core part 68 between 20° and 8° relative to the valve sleeve part 70, the lugs 102 of the valve sleeve part 70 engage the cut-outs 104 in the valve core part 68 to cause the valve sleeve part 70 to be rotated along with the valve core part 68. Such rotation of the valve sleeve part 70 causes the piston 58 to move within the chamber 56 and, hence, allows for the steerable wheels of the vehicle to be turned by the turning of the input shaft 40 of the integral steering gear 34. Thus, even if a loss in hydraulic fluid pressure has occurred, turning the input shaft 40 of the integral steering gear 34 enables the turning of the steerable wheels of the vehicle.

With reference to FIG. 1, the front steering gear 22 is actuatable in response to rotation of a vehicle steering wheel 110 to effect turning of the front set 14 of steerable wheels. The front steering gear 22 is operatively connected to the steering wheel 110. An input shaft, similar to input shaft 40 of FIG. 2, of the front steering gear 22 may be directly connected to the steering wheel 110. Alternatively, the input shaft of the front steering gear 22 may be actuated by an electric motor (not shown) that is responsive to operator-applied steering inputs to the steering wheel 110.

The steering apparatus 10 also includes a steering position sensor 112. The steering position sensor 112 is adapted to sense a steering position of the first set 14 of steerable wheels and to provide a steering signal indicative of the sensed steering position. FIG. 1 schematically illustrates the steering position sensor 112 being operatively connected with the front steering gear 22 for monitoring a portion of the front steering gear to determine the steering position of the first set 14 of steerable wheels. For example, the steering position sensor 112 may sense rotation of an output shaft, similar to output shaft 50 of FIG. 2, of the front steering gear 22 to determine the steering position of the first set 14 of steerable wheels. Alternatively, the steering position sensor 12 may sense the linear movement of the front axle 18, movement of another portion of the steering linkage 36, or the rotation of one or both of wheels 14a and 14b relative to a fixed reference.

The steering position sensor 112 is operatively connected to an electronic control unit (ECU) 116. The ECU 116 may be a microcomputer. The ECU 116 receives the steering signal from the steering position sensor 112 and, in response to the steering signal, controls actuation of the rear steering gear 24.

The rear steering gear 24 is operative to effect movement of the rear steering linkage 38, such as linear movement of the rear axle 20, for turning of the second set 16 of steerable wheels. The ECU 116 and an electric motor 118 are associated with the rear steering gear 24. The ECU 116 is operatively connected to, and controls energization of, electric motor 118. The ECU 116 may be connected with the electric motor 118 via a bus 120. The ECU 116 and the electric motor 118 communicate with one another over the bus 120. Thus, the bus 120 permits bi-directional communication between the electric motor 118 and ECU 116. An exemplary bus 120 may be the CAN bus of the vehicle 12.

The steering position sensor 112 provides control messages to ECU 116. The control messages, provided by the steering position sensor 112, determine when the ECU 116 should energize the electric motor 118 and also indicate the steering position for the second set 16 of steerable wheels. The ECU 116 determines if there are any faults associated with energization of electric motor 118 and actuation of the rear steering gear 24. The ECU 116 may also determine the rear steering position into which the second set 16 of steerable wheels have been actuated, after the energization of electric motor 118 and actuation of the rear steering gear 24. A rear steering position sensor (not shown) may be associated with ECU 116 for indicating the steering position of the second set 16 of steerable wheels. Alternatively, the ECU 116 may monitor a rotor position sensor associated with electric motor 118 and use data received from the rotor position sensor to determine the steering position of the second set 16 of steerable wheels.

The electric motor 118 receives electrical power from a power source (not shown). The power source preferably includes the vehicle battery and power regulating devices. The ECU 116 controls the energization, i.e., torque, amount of rotation, and direction of rotation, of electric motor 118. The output of the electric motor 118 is connected with an input shaft, similar to input shaft 40 in FIG. 2, of the rear steering gear 24 so that rotation of the output of the electric motor results in rotation of the input shaft of the rear steering gear 24, i.e., actuation of the rear steering gear 24. A gear assembly (not shown) may be used to connect the output of electric motor 118 to the input of the rear steering gear 24. A clutch (not shown) may also be operatively connected between motor 118 and rear steering gear 24.

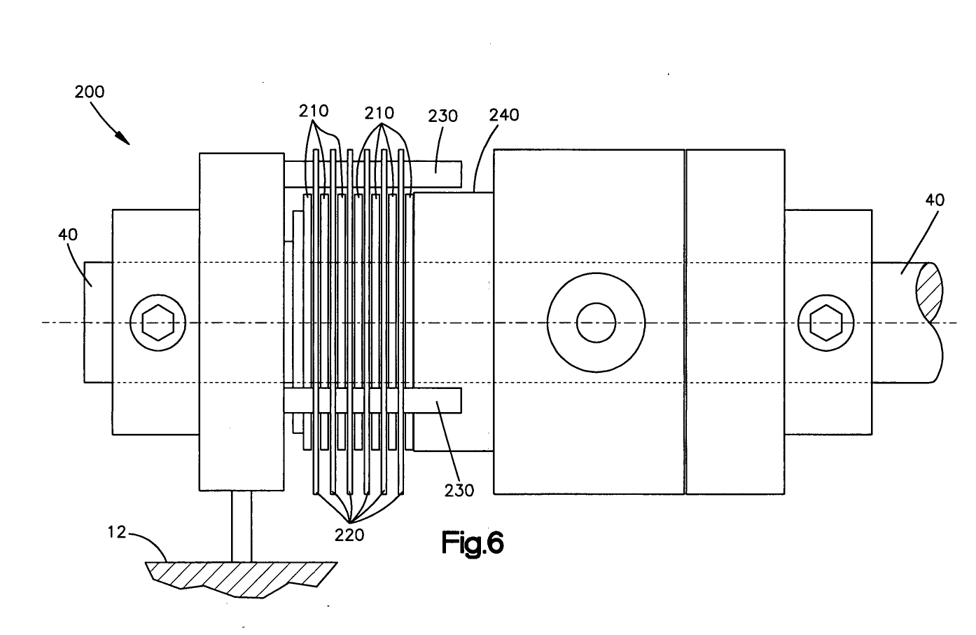

A braking mechanism 200 (FIG. 1), such as a friction brake, is connected to the vehicle 12. The braking mechanism 200 locks the position of the second set 16 of steerable wheels in the event of a failure of the ECU 116, the electric motor 118, or the bus 120. FIG. 6 shows an exemplary friction brake 200. The friction brake 200 includes a cartridge with inner brake pads 210 rotationally secured to an output shaft of the motor 118, such as the input shaft 40, for example. The inner pads 210 are interspersed with stationary outer pads 220. The outer pads 220 are rotationally secured to the cartridge by two or more torque pins 230. The outer pads 220 axially engage the inner pads 210.

The outer pads 220 are urged axially into engagement with the inner pads 210 by a device (not shown), such as a spring member. The friction between the inner pads 210 and the outer pads 220 prevent the inner pads and the shaft 40 from rotating relative to the vehicle 12 if the electric motor 118 is not energized. Thus, the position of the rear steering gear 24 and the position of the second set 16 of steerable wheels is locked when the motor 118 is not energized. The motor 118 overcomes the friction applied by the braking mechanism 200 when energized to actuate the rear steering gear 24 to turn the second set 16 of steerable wheels.

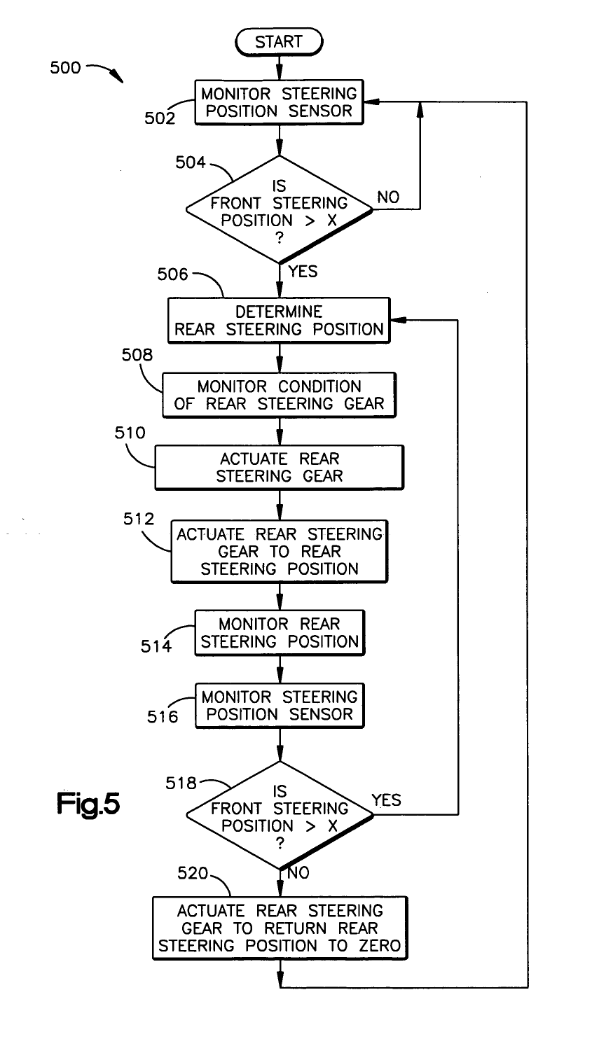

FIG. 5 is a flow diagram illustrating a control process 500 that may be performed by the apparatus 10 in controlling actuation of the rear steering gear 24. After starting, the process 500 proceeds to step 502 and the steering signal of the steering position sensor 112 is monitored. At step 504, the steering signal is compared to a predetermined threshold position, indicated as X, and it is determined whether the received steering position is greater than the predetermined threshold position X. If the determination at step 504 is negative, the process 500 returns to step 502. If the determination at step 504 is affirmative, the process 500 proceeds to step 506.

At step 506, a rear steering position associated with the received front steering position, from the steering position sensor 112, is determined. In step 506, a lookup table stored in a memory may be utilized. Alternatively, an algorithm to calculate the rear steering position associated with the received front steering position may be run.

At step 508, the condition of the rear steering gear 24 is monitored. For example, if a fault arises in the use of the rear steering gear 24, the ECU 116 may provide indication of the fault in a condition signal. The ECU 116 and/or the motor 118 may be turned off if a fault arises. The friction brake 200 locks the position of the rear steering gear 24 and the second set 16 of steerable wheels if the ECU 116 and/or the motor 118 are turned off.

At step 510, the rear steering gear 24 is actuated. The condition information received at step 508 may be considered in determining whether to activate the rear steering gear 24. The process 500 proceeds from step 510 to step 512. At step 512, a control message directing the ECU 116 whether or not to energize the electric motor 118 is provided, and if energizing, indicating a rear steering position into which the second set 16 of steerable wheels should be turned. At step 514, the steering position into which the second set 16 of steerable wheels have been actuated is monitored. The process 500 then proceeds to step 516.

At step 516, the steering signal from the steering position sensor 112 is again monitored to determine the steering position of the first set 14 of steerable wheels. At step 518, the steering position from step 516 is compared to the predetermined threshold position X and whether the received steering position is greater than the predetermined threshold position X is determined. If the determination at step 518 is affirmative, the process 500 returns to step 506. If the determination at step 518 is negative, the process 500 proceeds to step 520. At step 520, the rear steering gear 24 is actuated to return the steering position of the second set 16 of steerable wheels to a straight ahead or zero angle. From step 520, the process 500 returns to step 502.

As stated above, the apparatus 10 includes friction brake 200 fixedly attached to the vehicle 12. The friction brake 200 rotationally locks the input shaft 40 thereby fixing the position of the electric motor 118, the rear steering gear 24, the rear steering linkage 38, and the second set 16 of rear steerable wheels in position in the event of a failure of any part of the rear steering mechanism. The friction brake 200 may be any suitable device, such as shown in FIG. 6, that can effectively lock the electric motor 118 in case of loss of power or other failure.

Thus, a steering apparatus 10 in accordance with the present invention includes a front steering gear 22 that is actuated in response to rotation of the steering wheel 110 to effect turning of the first set 14 of steerable wheels. A steering position sensor 112 provides a steering signal indicative of the steering position of the first set 14 of steerable wheels. Actuation of the rear steering gear 24 is controlled to effect turning of the second set 16 of steerable wheels. In case of a failure of the rear steering mechanism, the friction brake 200 locks the rear steering mechanism in position.

Although the steering apparatus is described as having only one rear steering mechanism 24, one ECU 116, one motor 118 and one braking mechanism 200, the steering apparatus may include more than one rear steering mechanism, ECU, motor and braking mechanism to provide redundancy for turning the rear set 16 of steerable wheels.

From the above description of the invention, those skilled in the art will perceive improvements, changes and modifications. Such improvements, changes and modifications within the skill of the art are intended to be covered by the appended claims.

Having described the invention, we claim the following:

1. A steering apparatus for turning steerable wheels of a vehicle having first and second sets of steerable wheels, the steering apparatus comprising:
a first steering assembly actuatable to effect turning of the first set of steerable wheels;
a second steering assembly actuatable to effect turning of the second set of steerable wheels; and
a braking mechanism for locking the second set of steerable wheels in position in response to a failure of the second steering assembly.

2. The steering apparatus as set forth in claim 1 wherein the second steering assembly includes an electric motor operatively connected to a steering mechanism for, when energized, actuating the steering mechanism to effect turning of the second set of steerable wheels.

3. The steering apparatus as set forth in claim 2 wherein the braking mechanism is connected to an output of the electric motor, the braking mechanism locking the output of the electric motor in position in response to a failure of the second steering assembly.

4. The steering apparatus as set forth in claim 2 wherein the second steering assembly includes an electronic control unit associated with the electric motor, the electronic control unit, in response to a control signal, actuating the electric motor.

5. The steering apparatus as set forth in claim 2 wherein the steering mechanism includes an integral steering gear that is operatively connected to steering linkage associated with the second set of steerable wheels.

6. The steering apparatus as set forth in claim 1 wherein the braking mechanism is connected to an input to a steering mechanism of the second steering assembly, the braking mechanism locking the input to the steering mechanism in position in response to a failure of the second steering assembly.

7. The steering apparatus as set forth in claim 6 wherein the steering mechanism includes an integral steering gear that is operatively connected to steering linkage associated with the second set of steerable wheels.

8. The steering apparatus as set forth in claim 6 wherein the braking mechanism includes a first member rotationally secured to the input to the steering mechanism and a second member rotationally secured to the vehicle, said first member being engageable with the second member to lock the position of the second set of steerable wheels.

9. The steering apparatus as set forth in claim 8 wherein the braking mechanism urges the first member axially into engagement with the second member.

10. The steering apparatus as set forth in claim 1 wherein the first steering assembly includes an integral steering gear that is operatively connected to steering linkage associated with the first set of steerable wheels.

11. The steering apparatus as set forth in claim 10 wherein the second steering assembly includes an integral steering gear that is operatively connected to steering linkage associated with the second set of steerable wheels.

12. The steering apparatus as set forth in claim 11 wherein a sensor senses the steering position of the first set of steerable wheels.

13. A steering apparatus responsive to rotation of a steering wheel for turning steerable wheels of a vehicle having first and second sets of steerable wheels, the steering apparatus comprising:
a first steering assembly actuatable to effect turning of the first set of steerable wheels, the first steering assembly being actuated in response to rotation of the steering wheel;
a second steering assembly actuatable to effect turning of the second set of steerable wheels, the second steering assembly being actuated in response to rotation of the steering wheel;
a sensor for sensing a steering position of the first set of steerable wheels and for providing a steering signal indicative of the sensed steering position; and
a braking mechanism for locking the second set of steerable wheels in position in response to a failure of the second steering assembly.

14. The steering apparatus as set forth in claim 13 wherein the second steering assembly includes an electric motor operatively connected to a steering mechanism for, when energized, actuating the steering mechanism to effect turning of the second set of steerable wheels.

15. The steering apparatus as set forth in claim 14 wherein the braking mechanism is connected to an output of the electric motor, the braking mechanism locking the output of the electric motor in position in response to a failure of the second steering assembly.

16. The steering apparatus as set forth in claim 14 wherein the second steering assembly includes an electronic control unit associated with the electric motor, the electronic control unit, in response to a control signal, actuating the electric motor.

17. The steering apparatus as set forth in claim 14 wherein the steering mechanism includes an integral steering gear that is operatively connected to steering linkage associated with the second set of steerable wheels.

18. The steering apparatus as set forth in claim 13 wherein the braking mechanism is connected to an input to a steering mechanism of the second steering assembly, the braking mechanism locking the input to the second steering mechanism in position in response to a failure of the second steering assembly.

19. The steering apparatus as set forth in claim 18 wherein the steering mechanism includes an integral steering gear that is operatively connected to steering linkage associated with the second set of steerable wheels.

20. The steering apparatus as set forth in claim 18 wherein the braking mechanism includes a first member rotationally secured to an input of the steering mechanism and a second member rotationally secured to the vehicle, said first member being engageable with the second member to lock the position of the second set of steerable wheels.

21. The steering apparatus as set forth in claim 20 wherein the braking mechanism urges the first member axially into engagement with the second member.
